(19) United States
(12) Patent Application Publication
(10) Pub. No.: US 2009/0246569 A1
(43) Pub. Date: Oct. 1, 2009

(54) METHOD FOR REGENERATING A REFORMER

(75) Inventors: Marco Mühlner, Raduhn (DE); Stefan Kaeding, Zerrenthin (DE)

Correspondence Address: ROBERTS MLOTKOWSKI SAFRAN & COLE, P.C.;Intellectual Property Department, P.O. Box 10064, MCLEAN, VA, 22102-8064, US

(73) Assignees: WEBASTO AG, Stockdorf (DE); ENERDAY GmbH, Stockdorf (DE)

(21) Appl. No.: 11/721,362

(22) PCT Filed: Nov. 28, 2005
(86) PCT No.: PCT/DE05/02193

§ 371 Date: Jun. 11, 2007

(30) Foreign Application Priority Data
Dec. 10, 2004 (DE) 10 2004 059 647.6

(51) Int. Cl. H01M 8/04

(52) U.S. Cl. 429/17; 429/24

(57) ABSTRACT

A method for regenerating a reformer to which fuel (12, 14) and an oxidant (16, 18, 20) are continuously fed, the feed rate of the fuel (12, 14) being reduced for the purpose of regeneration as compared to the feed rate in the continuous operation. According to the invention, the feed rate of the fuel (12, 14 is reduced during a plurality of successive regeneration intervals as compared to the feed rate in the continuous (normal) operation. The feed rate of the fuel (12, 14) between the successive intervals is higher than during them. A corresponding reformer has temperature sensors for implementing control of the fuel feed.

### BACKGROUND OF THE INVENTION

1. Field of the Invention

The invention relates to a method for regenerating a reformer fed with fuel and an oxidant in continuous operation, the feed rate of the fuel being reduced as compared to the feed rate in continuous operation for the purpose of regeneration. The invention also relates to a reformer including a controller achieving regeneration of the reformer, the controller being suitable to feed the reformer with fuel and an oxidant in continuous operation, the feed rate of the fuel being reduced as compared to the feed rate in continuous operation for the purpose of regeneration.

2. Description of Related Art

Generic reformers and methods have a wealth of different applications, they serving, in particular, to feed a fuel cell with a gas mixture rich in hydrogen from which electrical energy can be generated on the basis of electrochemical reactions. Such fuel cells find application, for example, in motor vehicles as auxiliary power units (APUs).

The reforming process for converting the fuel and oxidant into reformate can be performed in accordance with various principles. For instance, catalytic reforming is known in which the fuel is oxidized in an exothermic reaction. The disadvantage in catalytic reforming is the high amount of heat it produces which can ruin system components, particularly the catalyst.

Another possibility of generating reformate from hydrocarbons is steam reforming in which hydrocarbons are converted into hydrogen with the aid of steam in an endothermic reaction.

A combination of these two principles, i.e., reforming on the basis of an exothermic reaction and generating hydrogen by an endothermic reaction in which the energy for the steam reforming is won from the combustion of the hydrocarbons is termed autothermal reforming. Here, however, additional disadvantages are met with in that means of feeding water need to be provided. High temperature gradients between the oxidation zone and the reforming zone pose further problems in the heat balance of the system as a whole.

In general, the reaction in which air and fuel are converted in a reformer into a hydrogen-rich gas mixture can be formulated as follows:

$${C}_{n} {H}_{m} + \frac{n}{2} {O}_{2} \to \frac{m}{2} {H}_{2} + n CO$$

Due to incomplete conversion of the hydrocarbons in this endothermic reaction—not reflected by the equation—side products, such as remnant hydrocarbons or soot can materialize which are deposited at least in part on the reformer, resulting in deactivation of the catalyst provided in the reformer possibly to such an extent that the catalyst is almost totally sooted up. This increases the drop in pressure in the reformer, resulting in it being ruined or needing to be regenerated.

In accordance with the prior art techniques, regeneration is implemented, particularly, by burning off the soot deposited in the reformer. This can produce high temperatures resulting in permanent, i.e., irreversible damage to the catalyst or substrate material. Apart from this, large temperature gradients hamper controlling the reformer when burning off of the soot is started. Since, with an excess of oxygen, oxygen can appear at the output of the reformer during burn-off, there is no possibility of using a reformer regenerated in this way in an SO fuel cell (SOFC) system.

### SUMMARY OF THE INVENTION

The invention is based on the object of achieving regeneration of a reformer so that the problems cited above are eliminated, in particular, avoiding high temperatures, large temperature gradients and unwanted oxygen appearance at the output of the reformer.

This object is achieved by the features described below.

The invention is based on a generic method in which, for regeneration purposes, periodically the fuel feed rate is reduced as compared to the feed rate during continuous operation and that during these periods, based on detected temperature conditions, the fuel feed rate is increased to above that in continuous operation. In normal operation, the reformer receives a continual feed of fuel and air at temperatures in the region of 650° C. and above, i.e., during continuous operation. The reformer works in thermal equilibrium so that, in stationary operation, no increase in temperature is to be reckoned with. The deposits, however, as described, result in the catalyst being deactivated by degrees. When the fuel feed is shut off in on-going operation of the reformer on a long-term basis, the soot is burned off at temperatures way above 1000° C. which can result in the catalyst or even the complete reformer being ruined. This is because the reaction in burning off the soot progresses exothermicly. Following complete burn-off of the catalyst, oxygen is output at the end of the reformer which would result in the anode of a SO fuel cell being ruined. By the method in accordance with the invention, it is now proposed to reduce the fuel feed pulsed, the individual pulses of which last for only a short time. Oxygen or air is applied to the soot deposit so that the oxidation process can commence, also resulting in an increase in temperature in the catalyst. But, before the temperature is so high that the reformer could suffer damage, the fuel feed is increased. Thus, at the end of a time interval with a reduced feed rate, part of the reformer is regenerated, i.e., rendered substantially free of soot or deposits. The reforming process can be continued after the regeneration interval. Since this progresses endothermically, the reformer cools off to normal temperatures. This procedure is repeated until the reformer is completely regenerated. Hence, regeneration is performed piecemeal. Reducing the fuel feed pulsed now makes it possible that no oxygen gains access to the fuel cell anode since the oxygen is consumed in the reaction.

Furthermore, the invention is sophisticated to advantage in that the fuel feed rate amounts to zero during at least one of the regeneration intervals. Due to the fuel feed being shut off completely during the regeneration intervals, burn-off of the deposits is now more efficient. When the fuel feed is not completely shut off, water production in the reformer is increased. It is this water that is able to remove the soot and other deposits from the reformer in accordance with the equation

C+H₂O→CO+H₂

It may also prove useful to measure the oxygen content in the substances leaving the reformer and the reformer translating into continuous operation when the oxygen content exceeds a threshold value. The oxygen content at the output of the reformer thus serves as an indicator of complete regeneration of the reformer. Keeping track of the oxygen content also ensures that no excess quantities of oxygen come into contact with the anode of the SO fuel cell. In this context, it is useful to measure the oxygen content with a lambda sensor.

Likewise, it may be provided that the oxygen content is measured by a fuel cell. To save having to install a lambda sensor, the electrical output values of the fuel cell can be used directly to detect an increase in the oxygen content.

The method in accordance with the invention is particularly useful with a reformer having a dual fuel feed, when one of the fuel feeds works during regeneration with a feed rate which substantially corresponds to the feed rate in continuous operation. With a reformer having a dual fuel feed there is thus a greater possibility of varying the fuel feed rate. This particularly applies to the possibility of operating the reformer unchanged in part while in other portions of the reformer regeneration occurs by changing the function.

The method in accordance with the invention is, in this context, usefully sophisticated in that the reformer comprises an oxidation zone and a reforming zone, that the reforming zone is feedable with heat, that the oxidation zone is fed with a mixture of fuel and oxidant in using a first fuel feed, the mixture being at least partly feedable to the reforming zone after at least partly oxidizing the fuel, that the reforming zone is feedable with additional fuel by using a second fuel feed and that the second fuel feed works during the contiguous time intervals with a reduced feed rate. The additional fuel feed thus forms, together with the exhaust gas from the oxidation zone, the starting mixture for the reforming process. By mixing the fuel with the exhaust gas, a small λ-value results (for example, λ=0.4) and in applying heat, an endothermic reforming reaction is achievable. As regards the regeneration in accordance with the invention, it is noted that operation of the reformer in the oxidation zone can continue to run unchanged while only the second fuel feed is shut off or reduced.

It is particularly useful that heat from the exothermic oxidation in the oxidation zone can be fed to the reforming zone. The thermal energy resulting in the oxidation zone is thus converted in the scope of the reforming reaction so that the net heat produced by the process as a whole does not result in problems in managing the temperature of the reformer.

It is usefully provided that the reforming zone comprises an oxidant feed via which additional oxidant is feedable, resulting in a further parameter being available for influencing reforming, in enabling it to be optimized.

The invention is particularly suitably sophisticated in that additional fuel is fed to an injection and mixing zone from which it can flow into the reforming zone. This injection and mixing zone is thus disposed upstream of the reforming zone so that the reforming zone makes a well mixed output gas available for the reforming reaction.

In this context, it is particularly useful that the additional fuel is evaporated, at least in part, by the thermal energy of the gas mixture emerging from the oxidation zone, thus enabling the reaction heat of oxidation to be also made use of to advantage for the fuel evaporation process.

It may also prove useful that the gas mixture generated in the oxidation zone is feedable to the reforming zone partly bypassing the injection and mixing zone, thus making available a further possibility of influencing the reforming process so that a further improvement of the reformate emerging from the reformer is achievable as regards its application.

The invention is based on the generic reformer in that the controller is suitable for periodically reducing the fuel feed rate as compared to the feed rate in continuous operation and that the fuel feed rate is increased above that during the regeneration time intervals, in thus translating the advantages and special features of the method in accordance with the invention also in the scope of a reformer.

The invention is based on having discovered that high temperatures, large temperature gradients, unwanted increases in pressure and an unwanted amount of oxygen appearing at output of the reformer can all be prevented when the fuel feed is variably pulsed, particularly with a pulsed shutoff of the fuel feed.

The invention will now be explained in detail by way of preferred example embodiments with reference to the accompanying drawings.

### BRIEF DESCRIPTION OF THE DRAWINGS

FIG. 1 is a flow diagram to assist in explaining a method in accordance with the invention; and

FIG. 2 is a diagrammatic illustration of a reformer in accordance with the invention.

### DETAILED DESCRIPTION OF THE INVENTION

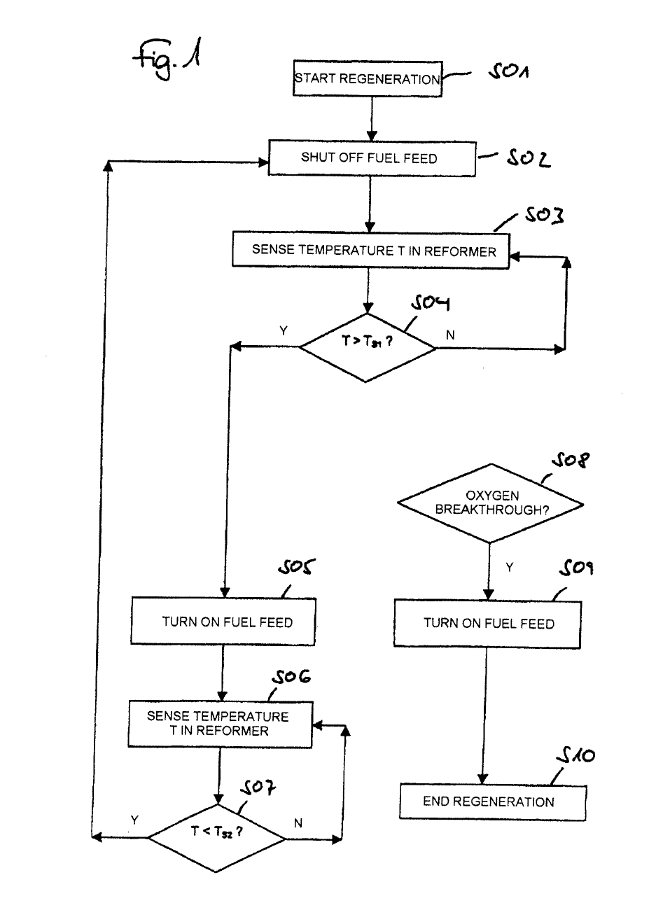

Referring now to FIG. 1, there is illustrated a flow diagram to assist in explaining a method in accordance with the invention. Following the start of regeneration of the reformer in step S01, the fuel feed is shut off in step S02. This is followed in step S03 by the temperature in the reformer being sensed, in step S04 it being determined whether the sensed temperature is higher than a predefined threshold value T_{S1}. If it is not, the temperature in the reformer is again sensed as per step S03 with the fuel feed shut off. If it is sensed in step S04 that the temperature exceeds the predefined threshold value T_{S1}, the fuel feed is returned ON in step S05. This is followed in step S06 by the temperature in the reformer again being sensed. In step S07, it is determined whether this sensed temperature is lower than a predefined threshold value T_{S2}. If it is not, the temperature in the reformer is again sensed as per step S06, without shutting off the fuel feed. If it is sensed in step S07 that the temperature is lower than the predefined threshold value TS2, the fuel feed is again shut off as per step S02 so that the next time interval for reformer generation can commence.

Parallel to monitoring the temperature, oxygen breakthrough in the reformer is monitored in step S08. This serves to establish the end of regeneration. Thus, when an oxygen breakthrough occurs and the fuel feed is shut off, then in step S09, the fuel feed is again turned ON, after which regeneration ends with step S10.

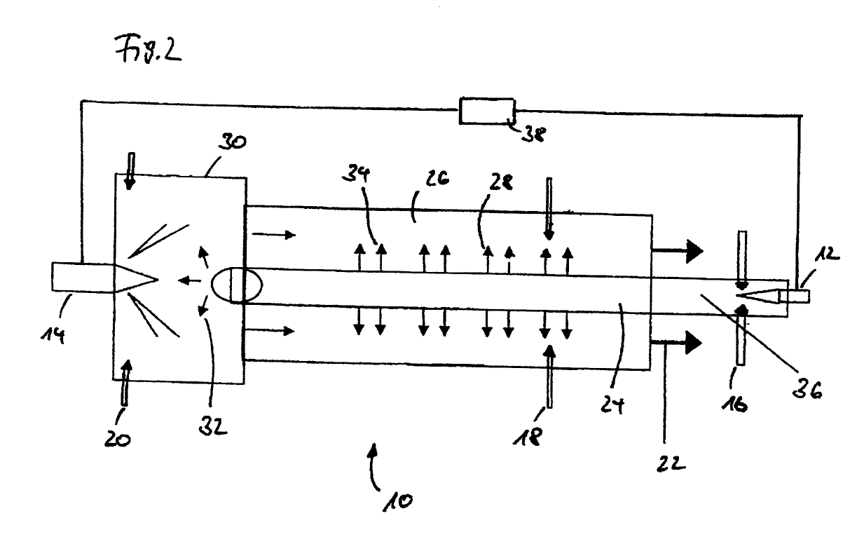

Referring now to FIG. 2, a diagrammatic illustration of a reformer in accordance with the invention is shown. The invention is not restricted to the special configuration of the reformer as shown here. Instead, regeneration in accordance with the invention can take place in various types of reformers as long as it is possible to reduce or interrupt the fuel feed at short notice. The reformer 10, as shown here, which is based on the principle of partial oxidation, preferably, without a steam feed, can be fed with fuel 12 and oxidant 16 via respective feeds. A possible fuel 12 is, for instance, diesel fuel, the oxidant 16 is air, as general a rule. The reaction heat resulting as soon as combustion commences can be partly removed in an optional cooling zone 36. The mixture then enters the oxidation zone 24 which may be realized as a tube arranged within the reforming zone 26. In alternative embodiments, the oxidation zone is realized by a plurality of tubes or by a special tubing arrangement within the reforming zone 26.

In the oxidation zone, the conversion of fuel and oxidant takes place in an exothermic reaction with λ=1. The resulting gas mixture 32 then enters an injection and mixing zone 30 in which it is mixed with fuel 14, whereby the thermal energy of the gas mixture 32 can support evaporation of the fuel 14. It may be provided for, in addition, that the injection and mixing zone 30 is fed with an oxidant. The mixture formed in this way then enters the reforming zone 26 where it is converted in an endothermic reaction with a lambda value of, e.g., λ=0.4. The heat 28 needed for the endothermic reaction is taken from the oxidation zone 24. To optimize the reforming process, additional oxidant 18 can be fed into the reforming zone 26. It is also possible to feed part of the gas mixture 34 generated in the oxidation zone 24 directly to the reforming zone 26, bypassing the injection and mixing zone 30. The reformate 22 then flows from the reforming zone 26 and is available for further applications.

A controller 38 assigned to the reformer which, among other things, can control the primary fuel feed 12 as well as the secondary fuel feed 14.

To undertake regeneration of the reforming zone 26, in the example embodiment as shown in FIG. 2, it may be sufficient to shut off the pulsed fuel feed 14 while the fuel feed 12 for maintaining the oxidant in the reformer is operated with no change in the feed rate. The catalyst provided in the reforming zone 26 is then burnt off with exhaust combustion gases containing oxygen.

It is understood that the features of the invention as disclosed in the present description, drawings and in the claims are significant to the invention both singly and in any combination.

1-13. (canceled)

14. A method for regenerating a reformer fed with fuel and an oxidant in continuous operation, the feed rate of the fuel being reduced as compared to the feed rate in continuous operation for the purpose of regeneration, comprising the steps of:
periodically reducing the feed rate of the fuel as compared to the feed rate of the fuel during continuous operation, and
based on temperature conditions detected in the reformer during regeneration periods, temporarily increasing the feed rate of the fuel to above the reduced rate of the regeneration periods.

15. The method as set forth in claim 14, wherein the feed rate of the fuel is zero during at least one of the regeneration periods.

16. The method as set forth in claim 14, comprising the further steps of:
measuring the oxygen content in substances leaving the reformer, and
shifting the reformer back into continuous operation when the oxygen content exceeds a threshold value.

17. The method as set forth in claim 14, wherein the measuring step is performed using a lambda sensor to measure oxygen content.

18. The method in claim 14, wherein the measuring step is performed using a fuel cell to measure the oxygen content.

19. The method as set forth in claim 14, wherein a reformer having a dual fuel feed is used, one of the fuel feeds working during regeneration with a feed rate which substantially corresponds to the feed rate in continuous operation.

20. The method as set forth in claim 19, wherein:
the reformer comprises an oxidation zone and a reforming zone,
the reforming zone is fed with heat,
the oxidation zone is fed with a mixture of fuel and oxidant using a first fuel feed, the mixture being at least partly fed to the reforming zone after at least partially oxidizing the fuel,
the reforming zone is fed with additional fuel using a second fuel feed, and
the second fuel feed operates at said reduced feed rate during the regeneration periods.

21. The method as set forth in claim 20, wherein heat from exothermic oxidation in the oxidation zone is fed to the reforming zone.

22. The method as set forth in claim 20, wherein the reforming zone comprises an oxidant feed via which additional oxidant is fed.

23. The method as set forth in claim 20, wherein
the additional fuel is fed to an injection and mixing zone, and
the additional fuel flows from the injection and mixing zone into the reforming zone.

24. The method as set forth in claim 20, wherein the additional fuel is evaporated at least in part by thermal energy of the gas mixture emerging from the oxidation zone.

25. The method as set forth in claim 23, wherein the gas mixture generated in the oxidation zone is fed to the reforming zone partially bypassing the injection and mixing zone.

26. The method according to claim 14, comprising the further steps of:
detecting temperature conditions in the reformer,
producing the temporarily increase of the feed rate of the fuel to above that of the regeneration periods when temperature conditions detected in the reformer exceed a first temperature threshold, and
terminating said temporarily increase of the feed rate when temperature conditions detected in the reformer drop below a second temperature threshold.

27. The method according to claim 14, comprising the further steps of:
measuring the oxygen content in substances leaving the reformer, and
shifting the reformer back into continuous operation when the oxygen content exceeds a value indicative of complete regeneration of the reformer.

28. A reformer comprising:
an oxidation zone and a reforming zone,
means for supplying heat to the reforming zone,
means for supplying a mixture of fuel and oxidant to the oxidation zone,
means for supplying fuel to the reforming zone, and
a controller for controlling operation and regeneration of the reformer,
wherein the controller is adapted to feed the reformer with fuel and an oxidant during continuous operation,
wherein the controller is adapted to periodically reduce the feed rate of the fuel as compared to the feed rate of the fuel during continuous operation for regeneration of the reformer, and
wherein, during regeneration periods, the controller is adapted to temporarily increase the feed rate of the fuel to above that of the regeneration periods based on temperature conditions detected in the reformer.

29. The reformer according to claim 28, further comprising temperature sensing means for detecting temperature conditions in the reformer, said temperature sensing means being connected to said controller; wherein the controller adapted to produce the temporarily increase of the feed rate of the fuel to above that of the regeneration periods when temperature conditions detected in the reformer exceed a first temperature threshold, and wherein the controller adapted to terminate said temporarily increase of the feed rate when temperature conditions detected in the reformer drop below a second temperature threshold.

30. The reformer according to claim 28, further comprising means for measuring oxygen content in substances leaving the reformer, and wherein the controller is adapted to shift the reformer back into continuous operation when the oxygen content exceeds a threshold value.
